(19) United States
(12) Patent Application Publication
(10) Pub. No.: US 2002/0184143 A1
(43) Pub. Date: Dec. 5, 2002

(54) Khater plus system

(76) Inventor: Ali Mohamed Khater, Nashua, NH (US)

Correspondence Address: ALI M. KHATER, 31 JESSICA Dr., NASHUA, NH, 03060, US

(21) Appl. No.: 10/141,669

(22) Filed: May 9, 2002

Related U.S. Application Data
(60) Provisional application No. 60/290,550, filed on May 14, 2001.

(51) Int. Cl. G06F 17/60; G06K 5/00

(52) U.S. Cl. 705/39; 235/379; 235/380

(57) ABSTRACT

A high level of security to protect all users against any kind of fraud and misused of the information that we use with our credit cards of any kind or debit cards or checks with or from any kind of Banks or financial organization or any credit cards form any creditors or gas companies or grand stores or social security numbers or any I D number or license or information that we use on the Internet like login names or login I.D. it's a one time usage password or PIN number that the user or the holder will use with the current information that he's using now to get more security of his information when he uses the information in any methods different than the direct way and uses his information personally and sign on a receipt or any kind of documents.

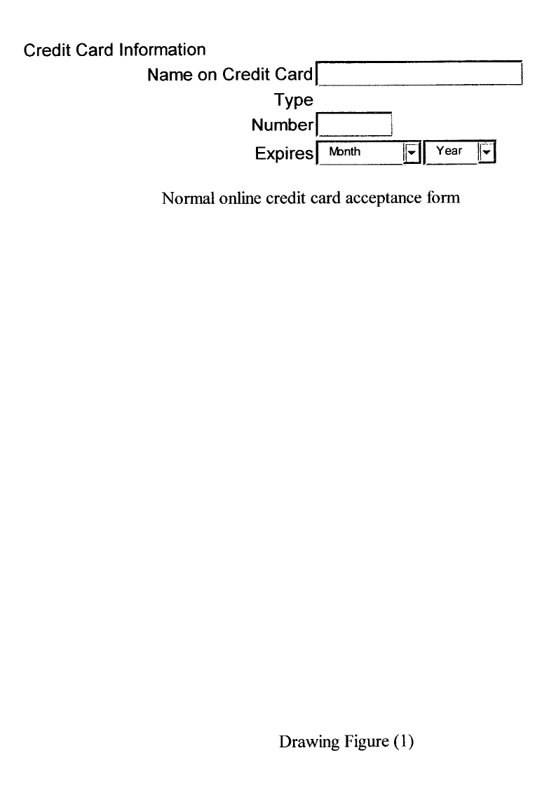

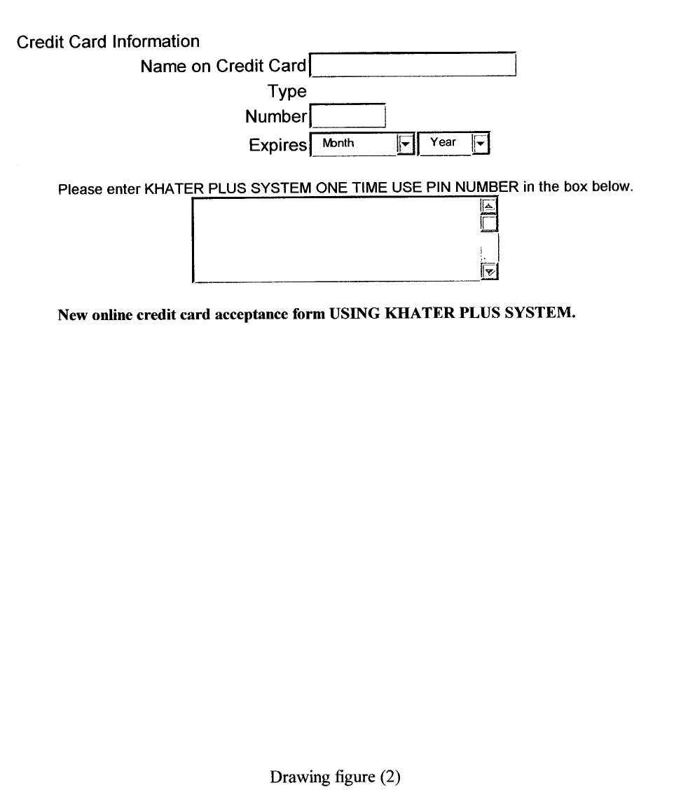

### BRIEF SUMMERY OF THE INVENTION

The invention offers a unique, simple, safe and ready to use solution to all credit card problems and it covers similar information that we want to keep away form the illegal usage From anybody except the owner or holder, it's a high level of security to protect all users against any kind of fraud and misused of the information that we use with our credit cards of any kind or debit cards or checks with or from any kind of Banks or financial organization or any credit cards form any creditors or gas companies or grand stores or social security numbers or any I D number or license or information that we use on the Internet like login names or login I.D. it's a one time usage password or PIN number that the user or the holder will use with the current information that he's using now to get more security of his information when he uses the information in any methods different than the direct way and uses his information personally and sign on a receipt or any kind of documents.

### BREIF DESCRIPTION OF THE DRAWING

FIG. (1)

It shows how companies use and share information on the internet when we buy any products online, it shows that we use the cardholder name, card number, expiration date and credit card type which is not secure and it's not safe as some hackers may have access to that information or the merchandise himself has these information and he can use it if he wants without the Permission of the cardholder.

FIG. (2)

It shows that with my new invention there is a new item has been added to the online order it's the one time usage PIN number, the same merchandise who already has the credit card information, can't deduct any additional amount (without permission from the card holder) for more security.

### DETAILED DESCRIPTION OF THE INVENTION

It is a system and process that will protect any information that we have now for credit cards or debit cards or checks from checking account or any kind of checks with or from any kind of Banks or financial system or organization or any credit cards for any creditors or gas companies or grand stores or social security numbers or any I D numbers or license numbers Or information that we use on the Internet like login names or login I.D. to check or review or to make any transactions on our accounts with Any Bank or organization or company, in all of these items, the information and the current security or passwords are not enough to protect us against anybody if he for any reason knows our information, but with the new system, which is “KHATER PLUS SYSTEM” which I invented, I added another level of security and safety that nobody except the authorized person can be able to use that information, that process and system depend on a new password system, these new passwords are changing every month or any other cycle and it's necessary for any transaction in case we will use our credit or debit cards or any Bank check or any other similar cards or services on line or if we want to buy by mail or fax or phone order or similar order in which the user or the card holder is not going to use the card in the direct normal way personally with his signature on the receipt.

KHATER PLUS SYSTEM It's a new level of security that will stop any kind of fraud or miss use of any kind of the information and data that we have now for credit cards or debit cards or checks from checking account or any kind of checks with or from any kind of Banks or financial system or organization or any credit cards form any creditors or gas companies or grand stores or social security numbers or any I D numbers or license numbers or information that we use on the Internet like login names or login I.D. to check or review or to make any transactions on our accounts with any Bank or organization or company, it's the maximum security for Using this information by the owner or user or bearer of these cards or I.Ds or checks, if by any chance someone knows these information and tries to use it without permission of the holder or the bearer or the owner or the user, he can't use it with my new system, if the issuer applies my new invention, or even against using these information to get any benefit for the same company or person who got permission for one time use of these information from the owner or the holder or the user for a one-time use only, so my new system even will stop that company or person who got the permission for one usage or more from using the same information that used before and it is belong to the holder or the user or the owner, for another transaction or operation again without a new permission from the owner or the holder or the bearer or the user who owns the card or the check or the ID or the social security or the login I.D. on the Internet, it means that the information given for a special usage for one or more time can't be used for a new transaction without a new permission

Definition and explanation

Issuer, in this system which I invented “KHATER PLUS SYSTEM “issuer means The company or the organization or any official authority or the person who issue the credit cards or the debit cards or the checks or the social security or national number who identify the person in any Nation or State or Country or any kind of I Ds that identify the person or the organization or the companies or license or any services on the Internet

Holder or bearer or user or owner, In this system which I invented “KHATER PLUS SYSTEM “Holder or bearer or user or owner means the person who has the rights to use the credit cards or the debit cards or the Bank checks or the social security or the license or any kind of credit cards or store credit cards or any benefit forms from any company or organization or Bank or government, or who has the right to use any kind of login services on line on the Internet

The security codes or codes system or the changing passwords or one time usage PIN numbers, In this system which I invented “KHATER PLUS SYSTEM “it means the codes Or the passwords that the issuer will send to the Holder or bearer or user or owner In a safe and secure way that nobody can see them or knows them except the Holder or bearer or user or owner and the fully secured and automated system which the issuer will use, the Issuer will send the codes or codes system or the changing passwords monthly or weekly or by any other cycle period that the issuer can choose, the issuer can send these codes by mail or Email or other way, and these codes or codes system or the changing passwords are expired if not used by the Holder or bearer or user or owner in the period or the cycle that the issuer determine, the Holder or bearer or user or owner will use the new codes or codes system or the changing passwords or the one time usage PIN numbers which he will receive in the next cycle or period like the next month or the next week, that method makes the codes or codes system or the changing passwords very useful and safe because they are always changing and they are always new, it is the new and the maximum level of security, also the issuer can generate a simple way for the user to get the security codes every cycle or any time he wants automatically or the user himself can generate the security codes like if he chooses his own security codes every month or every cycle and send it to the issuer who put it on the system for more security, or the user can go to the issuer's secure web site and picks his own monthly or cycle security codes, or the user can use every cycle special numbers or signs he gets from the issuer, with it he (the user) can change his monthly or every cycle security passwords, in all of these choices I call all of these ways and methods “MY OWN CHANGING PASSWORDS” it means that the user can get his own security codes whenever he wants to or every month or every cycle and he can uses them in any transactions as a maximum level of security in addition to any current or available security methods or passwords, also the issuer can help the user to generate a monthly or weekly cycle a new codes or passwords in any similar ways, in another way these security codes will be the safe and secure way to identify that the user or owner is the only authorized person to use the credit cards or the checks or any services

Data that we have now, Normally we have some information and data that the companies or creditors or banks or government or local official departments or any issuer that issue these credit or debit cards or I D or license or social security cards or ID or national number which any person get when he born to identify him which this number is given to the person only, these data and numbers and security codes or numbers

And date of issue and date of expiration, or any ID or login name on any web sites provide a services with login names or I.Ds and passwords or whatever data we have now (I found out that they are not enough to protect us from illegal use) and that what made me invented the new system (KHATER PLUS SYSTEM)

KHATER PLUS SYSTEM, It is the system that I invented and which will protect the credit card holders or ID holders or license holders or debit cardholders or social security holders or ID or national number or any similar cards or checking account holders or any other cards that give their bearer or holder any benefit and any person or user login name on the internet, because with the normal and current data and information and passwords that these cards or ID(s) or license are not enough to protect the holder if it's used without the owners or the cards holders or bearer's permission, in misused or fraud cases like credit cards fraud or if somebody uses the information of any of these cards or I.Ds or licenses or checks without authorization from the owner or holder, my new idea, my new invention is to add new security codes that the owner or bearer or holders of these items mentioned before or similar services will receive from The issuer every month or every week or every 3 month or every 6 month or every year or any other cycle that the issuer will determine, in order for the holders to use these one time use codes if they want to use their credit or debit cards or checks or I.D. or license or social security numbers or any identifies cards or services similar to that on line on the Internet or by fax or by phone or any other way of usage in which the holders are not going to present heir cards or checks or social security or national cards or other similar services by themselves in the normal usage way personally, so they can use these changing Codes (my new system) to identify that they are the only persons who own or hold them, and They are the only authorized persons to use them

KHATER PLUS SYSTEM, we need it Because we are not safe and secure with the information and data and any kind of current password that we have now before my new invention, and anybody can use our credit or debit cards or social security numbers or national numbers or check or any other similar cards or license or ID or any service on the Internet with I.D. or login name and password or any thing that we use and benefit from it.

KHATER PLUS SYSTEM, with it the issuer will issue the changing secure codes every month or every week or another cycle he will choose, these changing codes or the one time use PIN Numbers, the user will use them as a security method for his usage and transactions, the issuer or the companies or the organizations or banks or creditors or any other issuers of any item I mentioned, that the holders or owners use or get benefit from, will (the issuer) manage that system automatically to make sure that any transaction will be made by the authorized person only using my new system (the changing codes) by matching any secure code (one of the one time usage PIN Numbers) the user will use in any transaction making sure that it's one of the security codes given before to the use and valid for the determine period by the issuer

KHATER PLUS SYSTEM, they are not fixed, and they are new because the issuers send them to the holders or bearer or holders every month or every cycle, the issuer will decide according to the policy which he declares to the holders or users and also the issuer can choose a special way for the user to pick or choose his own secure changing codes (the one time usage PIN Numbers).

KHATER PLUS SYSTEM, changing passwords or codes or the one time PIN Numbers are expire if not use within the period they must be used in like if they are issued to use within a month and if they are not used then they are cancelled and the holders or users must use the new codes witch the issuer will send every month or any cycle according to his policy, that add another level of security.

KHATER PLUS SYSTEM, security codes or the one time usage PIN Numbers witch I invented to use as a security for holder or owner or user must be valid for a certain period or cycle like on month or one week or every 3 month or every 6 month or every year or any other cycle that the issuer will decide or for a certain period if it will be according to the law in some cases if the governments or officials determine that by law, that makes the security codes which I add as security system, more secure and more safe because they are always changing, they are not the same every Month or every cycle for more safety.

KHATER PLUS SYSTEM

It is the security codes that the credit card or debit card holders or checking account holders or social security owner or license holders or any similar cards or I.D will receive every month or every cycle from the issuer in order to use these changing codes (every cycle) in some cases in witch the holders or owners or users or bearers will use their cards or checks or similar cards or I D in a way that is different than the direct and normal usage in which they need these security codes like if they want to buy anything online on the Internet or by mail order and they want to pay by credit card, in these cases and with my new system they will need one of my changing codes in addition to the normal data like card number and name and expiration date and name of the issuer or if a creditor wants to run credit check on a client to check his credit history from time to time to make sure that he has no credit problems (in that case the creditor must call the person who wants the credit and ask to get one of these one Time usage PIN numbers -security codes that he receives from the social security authority as more security to proof that he is the only holder of this social security number not someone else) another example if anybody wants to buy any thing using one of his bank check if he is buying online or by phone or fax, so he would need his bank name and check number and routing number and amount (plus one of my new codes—my new system)

KHATER PLUS SYSTEM, some examples to make the new system that I invented more clear and easy to understand, examples of the credit cards and I Ds that will benefit from my new system of safety and security, it's an example because any similar services can also use my system for more security in any transaction

All Credit cards:

All Debit cards:

Social security numbers:

Checking account checks or any kind of checks:

Grand store credit cards:

Gas station credit cards:

National numbers (in some Countries or Nations or States):

Any login service on the Internet

I. D. (Identification number):

Licenses:

Cards or coupons that gives their owners or users some benefit:

Any similar service that now use same kind of security to get any kind of benefits to the

holder

KHATER PLUS SYSTEM, why we need that system? Because the information that we currently have on the credit or debit cards or checks or our social security numbers or any similar systems or credit cards, are not enough to protect us against credit card fraud or debit card fraud or using our I.D.s or social security data by unauthorized People or organization or companies.

Who issues the one time usage PIN numbers (security codes or changing passwords)? The issuer of the credit card or debit card or the bank who issues the checks or the social security authority or any issuer of any similar card or system or services, the issuer wants to protect the holder against any unauthorized usage or against any kind of fraud, or the issuer wants to make sure that the card or check holder (or any holders for any similar card or system) he is the holder not anybody else by using the special codes the holder receives every month or every cycle from the issuer

How is the holder will receive the codes the security codes or the changing passwords, The cardholder will receive the codes with his monthly statement or report or when the holder ask the issuer to send to him some of these codes by mail or email or by hand (personally) or any other way that nobody can receives these codes but the holder himself, that is why they are secure and safe to use as additional system to make any transactions safe 100% and there is no fraud and there is nobody can use the credit cards or debit cards or Bank checks or social security numbers or any kind of I.D. or license or any similar cards or system or services, except the holder himself.

Also the issuer can generate a simple way for the user to get the security codes every cycle or any time he wants automatically or the user himself can generate the security codes like if he chooses his own security codes every month or every cycle and send them to the issuer who put them on the system for more security or the user can go to the issuer's secure web site and picks his own monthly or every cycle security codes, or the user can use every cycle special numbers or signs he gets from the issuer, with it he ( the user) can change his monthly or every cycle security passwords like to add special number or words to the current changing passwords to make them new and valid for the new cycle, in all of these choices I call all of these ways and methods “MY OWN CAHANGING PASSWORDS” it means that the user can get his own security codes whenever he wants to or every month or cycle and he can uses them in the special transactions as a maximum level of security

Are the codes fixed? no they are not fixed but they are always new, they are changing, they are expires if not used by the user or holder, at the end of the period determine by the issuer or the company or the organization that issued the card or the service or the bank that issued the checks etc., they are useless if not used after the cycle finished, that makes them more secure

How are the one time usage PIN Numbers or the codes look like? they can be numbers or words or signs or mix of all of these things and the holders receive them in a safe and secure way like carbonated paper or sealed envelopes like credit card companies or banks send current passwords to the users

This system is simple and easy to use

Holders, they will receive the security codes monthly or by any cycle the issuer will determine or at the order of the holder if he needs more or if he needs special codes according to his usage specially if he is a company or organization etc.

The issuer, it's the company or bank or organization or the government who issue the credit or the debit cards or the social security numbers or the I.D number or who publish the service on the Internet and also the issuer according to my new invention which I invented “KHATER PLUS SYSTEM “will send the security codes or the passwords to the holder or bearer or user or owner in a safe and secure way that nobody can see them or knows them except the holder or bearer or user or owner and the fully secure and automated system which the issuer will use to match all of these changing passwords (my new system), the issuer will send the codes or codes system or the changing passwords monthly or weekly or by any other cycle period that the issuer can choose and these security codes or codes system or the changing passwords are expired if not used by the holder or bearer or user or owner in the period or the cycle that the issuer determine and the Holder or bearer or user or owner will use the codes or codes system or the changing passwords which he will receive in the next cycle or period like the next month or the next week, that make the codes or codes system or the changing passwords very useful and safe because they are always changing and they always new, it is the new and the maximum level of security, also the issuer can generate a Simple way for the user to get the security codes every cycle or any time he wants automatically or the user himself can generate the security codes like if he chooses his own security codes every month or every cycle and send it to the issuer who put it on the system for more security, or the user can go to issuer's secure web site and picks his own monthly or every cycle security codes, or the user can use every cycle special numbers he gets from the issuer that with it he (the user) can change his monthly or every cycle security passwords to make them always new, in all of these choices I call all of these ways and methods “MY OWN CHANGING PASSWORDS” it means that the user can get his own security codes whenever he wants to or every month or cycle and he can uses them in the transactions as a maximum level of security

Usage of the security codes, when ever is the holder wants to use his card or check or any similar cards or systems or service in the way that is not the basic way in which he uses the card or check or any similar by his personal usage with signing or give his permission to use these things, as an example if the holder wants to use his credit card or debit card or check to buy anything on the Internet or by mail order or phone or fax order, the issuer will add the new and changing codes (my system) as standard process and methods to use in addition to the current security system to make sure that whoever make this kind of transaction is the authorized person or the owner or the right user.

I claim:

1. A method of providing a secure new system against fraud or misuse of personal information using one time usage PIN Number by all users of credit cards of any types or debit cards or Bank checks or Social security Identification Number or any similar system when the user uses his information which he gets from the system issuers,
a. user or owner will use the one time usage PIN number only one time with one transaction,
b. the user will use the one time usage PIN number in addition to any current information that he uses now,
c. the user receives a number of one time usage PIN numbers from the issuer of the credit card or the Bank or any similar service,
d. the one time PIN numbers are valid for one month or any other period that the issuer may determine,
e. if the user does not use the one time usage PIN numbers with the time frame which the issuer determine he (the use) can't uses these PIN numbers after that period which the issuer determine,
f. the one time usage PIN numbers only used in the indirect ways of usages by the credit card holder or the owner of any similar service with all kind of transactions when he is not personally presented and uses his card or checks or ID or similar service.

2. According to claim 1 user or owner receives a package of special PIN numbers from the issuer every cycle with his statement and he can ask for more PIN numbers if he wishes this cycle could be every month or every week and these special PIN numbers is for one time usage only.

3. According to claim 1 the one time usage PIN numbers are for on time use only with one transaction and are not valid after that.

4. According to claim 1 the package of that one time usage PIN numbers are expire if not used within the cycle determine by the issuer to give them maximum security.

5. The issuer of any types of credit cards or similar service determine a validity period for the one time usage PIN Numbers if the credit card user or the user who uses one of his checks does not use all or some of these one time PIN Numbers in that period then they can't be use and they are useless.

6. If the credit card user or similar system or service uses his credit card or service by himself in a direct way by presenting his credit card or his check or any ID or system of any kind and he sign a receipt and he can't use one of the one time usage PIN number as he does not need it he will use my new system in any other ways of usage like,
a. when he uses one of his checks or his credit card or any other service on line to buy any item on the Internet,
b. if he order by FAX,
c. if he order by phone,
d. if he order by Mail,
e. if he uses any kind of automatic monthly payment.

7. According to claim 1 adding this new system the one time usage PIN number to the current information which most of credit card companies and merchandise use in claim 6 (a to e) like bank check NO./routing NO./bank name/customer name, also like any type of credit card when they use type of card/card NO./Expiration date! name of the customer I added by my new invention another item which is special passwords valid for one time usage.

8. Losing a credit card or check book or social security ID or any system similar is not a problem with my new invention as the person found them or steel them still needs one of the special codes which needed as a new level of security as one time usage PIN number usage is needed for each transaction as of course the unauthorized person will use the info he found on line or by fax or mail or by phone order or as an example on line on the internet he will find a new line or square where he must enter one of the new one time use PIN number which he dose not have and the only person who has them is the owner or holder.

9. I claim that with my invention I made all personal information that we all have with all types of credit cards or checks or similar services I made it unusual if someone steal it or knows it I can now give my credit card information to any person with all available amount asking him to try to use it but he can't as he still need something is not available to him.

10. According to claim 1 one time usage PIN numbers are always new according to the cycle that the issuer will determine.

11. According to claim 1 one time usage PIN numbers are an added information and consider a new element to the current elements that all types of credit cards or debit cards or checks or similar services have.

12. According to claim 1 my new invention is even stronger and much efficient than any current way of protection that all of credit cards of any types are having now even the electronic ship on some of them which matches the information without entering it by the user because the info still available to many people during your normal usage.

13. I claim that my new system that based on adding a one time usage PIN numbers to the current information to any types of credit cards can be used successfully with all kinds of credit cards or debit cards or Bank checks or social security number or any similar service or systems uses I D number and password.

14. I claim that my invention put a new standard for usage of credit cards of any types or checks or any similar service that standard is either the user or the holder or the owner uses his card or ID by himself in a direct way of usage when he sing a receipt or he uses one of my new system PIN numbers that is valid for one time usage only its HATER PLUS SYSTEM safe and secure new way.
